(19) United States
(12) Patent Application Publication
(10) Pub. No.: US 2020/0109783 A1
(43) Pub. Date: Apr. 9, 2020

(54) METHOD FOR PRODUCING A SEAL BETWEEN TWO ROOF FRAME ELEMENTS, AND ASSEMBLY COMPRISING TWO ROOF FRAME ELEMENTS

(71) Applicant: Webasto SE, Stockdorf (DE)

(72) Inventors: Thomas STALTMAYER, Stockdorf (DE); Horst SCHMIDHUBER, Stockdorf (DE)

(21) Appl. No.: 16/495,743

(22) PCT Filed: Feb. 7, 2018
(86) PCT No.: PCT/EP2018/053088

§ 371 Date: Sep. 19, 2019

(30) Foreign Application Priority Data
Mar. 29, 2017 (DE) 10 2017 106 751.5

(51) Int. Cl. F16J 15/02; B62D 27/04

(52) U.S. Cl. CPC F16J 15/022; B62D 27/04

(57) ABSTRACT

A method for producing a seal between two roof frame elements for a vehicle roof is described and having the steps of providing the two roof frame elements in such a manner that an overlap region is formed, wherein at least one gap is formed in the overlap region; mechanically supported introduction of a hardening sealing material into the gap by an applicator device in such a manner that the sealing material flows into the gap and subsequently hardens in order to form a gap seal. Arrangements resulting from the described methods is also disclosed.

Method for producing a seal between two roof frame elements and assembly comprising two roof frame elements

The invention relates to a method for producing a seal between two roof frame elements. The invention further relates to an arrangement having two roof frame elements.

In roof frame constructions which are produced in several pieces for vehicle roofs of motor vehicles, it is necessary in many regions to provide seals in order to prevent water or other fluids, for example, from entering dry regions of the vehicle.

It is desirable to provide a method for producing a seal between two roof frame elements for a vehicle roof and an arrangement which contribute to a particularly effective seal.

A method for producing a seal between two roof frame elements for a vehicle roof is disclosed according to the invention. The method has the steps of:
providing the two roof frame elements in such a manner that an overlap region is formed, wherein at least one gap is formed in the overlap region;
mechanically supported introduction of a hardening sealing material into the gap by means of an applicator device in such a manner that the sealing material flows into the gap and subsequently hardens in order to form a gap seal.

As a result of the mechanical introduction of a flowing sealing material or a flowing sealing mass, a contribution is made to obtaining a particularly effective gap seal. A high level of reproducibility is advantageously provided by the mechanical application so that a high level of sealing efficacy can be achieved. Unlike a manual sealing material application, for instance by filling filler mass, for example, a desired gap seal can be achieved by adjusting and determining suitable process parameters. Furthermore, a contribution is made to lower production costs in comparison with a manual application.

The method described is a pressureless method. Unlike the known RIM methods (reaction injection molding), in the method described the sealing material hardens under atmospheric pressure. A closed shaping component is not absolutely necessary in the method. As a result of the method described, a high surface quality for the gap seal can be achieved.

The method described is, for example, based on a WST method or WST+ method (Window Spray Technology), as described, for example, in DE 10 2012 003 045 A1, DE 60 2004 003 219 T2 or EP 2 799 201 B1, wherein special shaping components for determining the form of the gap seal are not absolutely necessary.

The roof frame elements are, for example, components of a roof frame for movable roof elements, for example, sliding roofs, or fixed roof elements, for example, glass covers or panorama sun roofs. The roof frame elements can also be referred to as retention frames and are typically arranged along an edge of a roof opening in a vehicle roof. The roof frame elements are constructed, for example, as metal components, metal frames or sheet metal components, such as sheet steel components. The roof frame elements can be painted at least in the region of the gap, which does not have any effect on the use of the method disclosed.

In the operatively arranged state of the two roof frame elements, they overlap at one or more connection locations, also referred to as joints, sheet connection locations or butt sheet connection locations. This overlap is necessary for assembly reasons inter alia. The gap is formed in at least one such overlap region.

The gap acts as a shaping component for the method described. The gap is constructed, for example, as a groove or empty space. The gap is, for example, open toward one side, for example, toward an upper side, so that the sealing material can be introduced. In other words, the gap itself forms an open shaping component. Consequently, the gap determines a shaping for the gap seal. Optionally, one or more additional separate shaping component(s) can also be provided in order to obtain a desired shaping for the seal, for example, a particularly smooth surface.

The formation and hardening of the gap seal can be carried out in a particularly reliable and controlled manner by means of such an additional shaping component. The shaping component is constructed, for example, in two pieces and has a separate upper portion and lower portion. For example, the shaping component is formed in a U-shaped or T-shaped manner and seals a predetermined portion of the gap 13 at an upper side and/or lower side of the roof frame elements. In this manner, by means of the shaping component, for example, a two-sided planar sealing and filling of undesirable empty spaces is possible.

The shaping component is produced, for example, from silicone or has silicone at least in the region of the shaping face(s) thereof and produces a soft shaping tool which allows a controlled inward flow of the sealing material and which reliably limits the formation of the gap seal. In this manner, a stepless, particularly flush and attractive final result of the gap seal can be achieved in relation to adjacent edges and surfaces.

In order to allow in the sealing material, the shaping component may have one or more inlet openings which allow a controlled introduction of the sealing material into the gap or the cavity which is formed with the gap and the shaping component. Alternatively or additionally, the shaping component may have an open front side or rear side, by which the sealing material can be spread or inserted by means of the applicator device.

By means of the method described and in particular using an additional shaping component, joint locations between the roof frame elements can be reliably sealed and particularly flat or planar transition faces can be formed. In this manner, undesirable sharp edges and changes in height of the gap seal can be prevented or at least reduced. The shaping component surrounds the joint location or the overlap region with the gap as a shaping tool which is kept small locally and seals it with respect to an uncontrolled run-out of the sealing material. The method allows a robust and repeatable implementation as an automated process so that in particular no operationally unreliable manual sealing and filler work is necessary. Subsequent processing operations are therefore unnecessary or are at least substantially less substantial. The applicator device is, for example, a device having a metering head or nozzle head, via which the hardening sealing material is applied in the gap. The application is carried out, for example, by a spraying or nozzle method.

The sealing material can also be referred to as a sealing material admixture which is flowable and which disperses spatially and hardens in the gap. The sealing material is, for example, a polyurethane formulation. So that the sealing material has a sufficient ability to flow, a low viscosity is necessary. For example, at a shearing speed of 1/s, the viscosity should be less than 100,000 mPa*s, preferably less than 50,000 mPa*s, less than 20,000 mPa*s or less than 10,000 mPa*s. In other words, highly viscous material is not used.

According to an embodiment, a movement of the applicator device and/or a volume flow of the sealing material from the applicator device for introduction into the gap can be mechanically controlled. For example, a movement speed of the applicator device is controlled. The applicator device is, for example, constructed as a movable applicator device or has a movable applicator. The applicator is, for example, constructed as a nozzle head or letterhead, as described above. The applicator device or the applicator moves, for example, along the gap in order to introduce the sealing material. In other words, the method is robot-supported so that an operationally reliable application for producing the seal is ensured. The application is carried out, for example, continuously, but alternatively it may also be carried out discretely, for example, by means of a plurality of spray bursts or nozzle travels.

According to an embodiment, the sealing material is introduced into the gap in such a manner that the sealing material hardens so as to form a smooth sealing surface. The gap seal consequently has a smooth surface. For example, the gap seal hardens in such a manner that the sealing surface is flush with adjacent surfaces of the two roof frame elements. In other words, for example, a common surface between the two roof frame elements and the gap seal is achieved. Again in other words, the gap seal connects the adjacent surfaces of the roof frame elements in the hardened state so that a common level surface is formed. The gap seal is thereby free from sinking locations. A better sealing action can thereby be achieved, particularly if additional elements are arranged directly on the gap seal and the roof frame elements. Such an additional element can consequently cooperate with the gap seal in a fluid-tight manner, wherein, for example, a fluidic cannot be introduced between the gap seal and the additional element.

According to an embodiment, a shaping component is placed against the first or second roof frame element along at least a portion of the gap, wherein the shaping component has a shaping face and delimits, together with the gap, a cavity, into which the sealing material is introduced. The term cavity is intended to be understood to be an empty space which may not necessarily be closed, but may also be open at least at one side. The sealing material can be applied to the shaping face so that together with the gap a shaping for the gap seal is predetermined. The shaping component can be arranged along the portion which is intended to be applied, alternatively it may also be movable and be arranged depending on the application location. After the application, the shaping component is removed in an additional step.

According to an embodiment, the shaping component has a resilient lip which can be displaced by means of the applicator device in order to provide access to the cavity. This is based, for example, accordingly on the above-mentioned WST+ method. For example, the shaping component forms together with the gap a closed cavity. By means of the applicator device, the resilient lip is bent or displaced in a point-like manner for the application in order to introduce the sealing material into the hollow space accordingly.

According to an embodiment, an additional shaping component is positioned along at least the portion of the gap so that both shaping components delimit, with the gap, a closed cavity into which the sealing material is introduced. By means of the additional shaping component, a more complex geometry or shaping for the gap seal can readily be achieved.

According to an embodiment, after the introduction of the sealing material, in an additional step an adhesive material, in particular an adhesive bead, or an adhesive seal is applied to the two roof frame elements in such a manner that the adhesive material or the adhesive seal intersects in a fluid-tight manner with the sealing material which has hardened in the gap. In other words, the adhesive material or the adhesive seal extends over both roof frame elements and the gap seal. For example, the gap seal extends transversely to the adhesive material or the adhesive seal. The region between the gap seal and the adhesive material or the adhesive seal is thereby sealed. The adhesive material or the adhesive seal is positioned on the gap seal in a planar manner. As a result of the method described, consequently, leaks between the gap seal and such adhesive materials or the adhesive seals which intersect with the gap seal are prevented. Such adhesive materials or adhesive seals are, for example, provided for the assembly of glass covers, sliding roof constructions or the like.

Furthermore, an arrangement with two roof frame elements for a vehicle roof of a motor vehicle is disclosed. The two roof frame elements are arranged in such a manner that an overlap region is formed, wherein at least one gap is formed in the overlap region. A hardening sealing material is introduced into the gap according to a method according to any one of the preceding claims so that a gap seal is formed.

The arrangement substantially allows the above-mentioned advantages and functions. The arrangement can be developed according to one or more features described above.

According to an embodiment, an adhesive material, in particular an adhesive bead, or an adhesive seal is applied to the two roof frame elements in such a manner that the adhesive material or the adhesive seal intersects in a fluid-tight manner with the sealing material which has hardened in the gap, the gap seal.

Additional advantages, features and developments will be appreciated from the embodiment which is explained below in connection with the Figures.

Identical, similar or identically acting elements can be provided with the same reference numerals over all the Figures. It may be noted that all the reference numerals already introduced are not set out in all the Figures.

In the drawings:

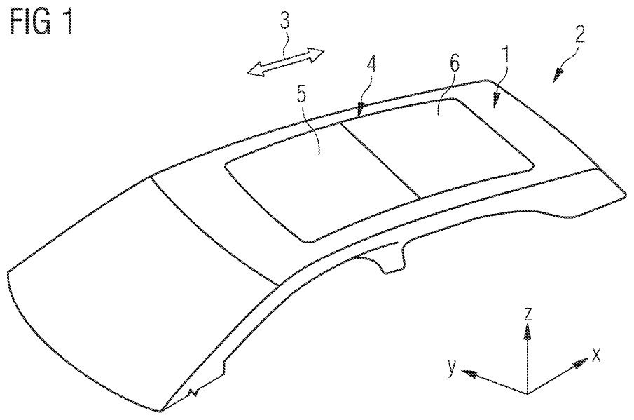

FIG. 1 is a schematic, perspective view of a vehicle roof of a motor vehicle,

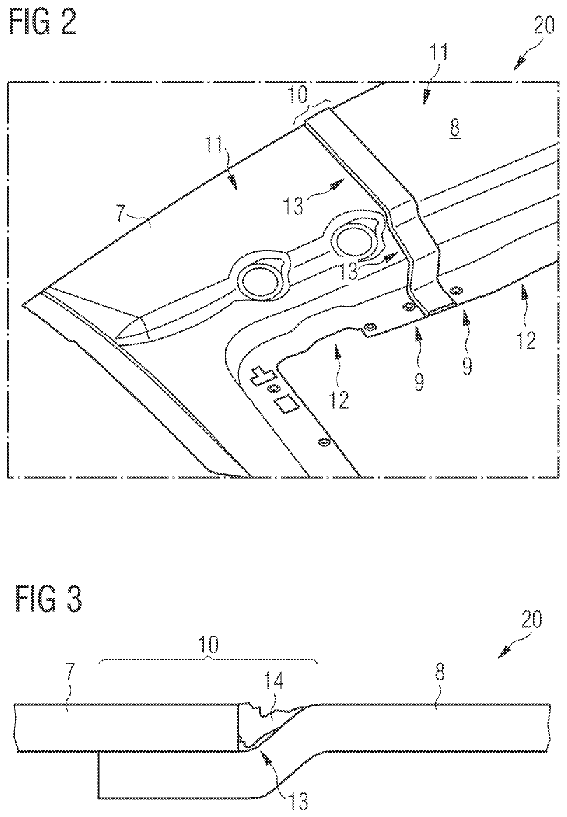

FIG. 2 is a perspective view of two welded roof frame elements of a roof frame of the vehicle,

FIG. 3 is a schematic cross-section of a joint of the two roof frame elements with a seal,

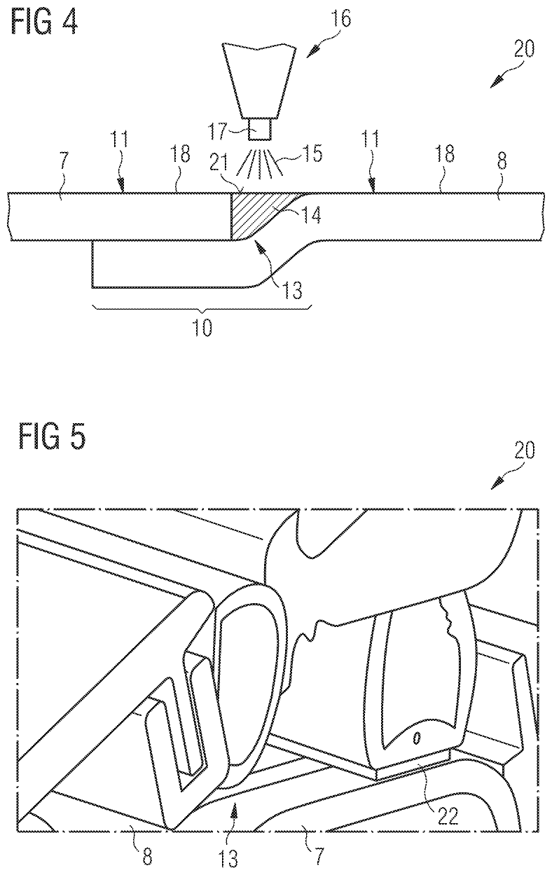

FIG. 4 is a schematic cross-section of a joint of the two roof frame elements with a seal according to an embodiment of the invention,

FIG. 5 is a perspective cross-section with two roof frame elements according to an embodiment of the invention,

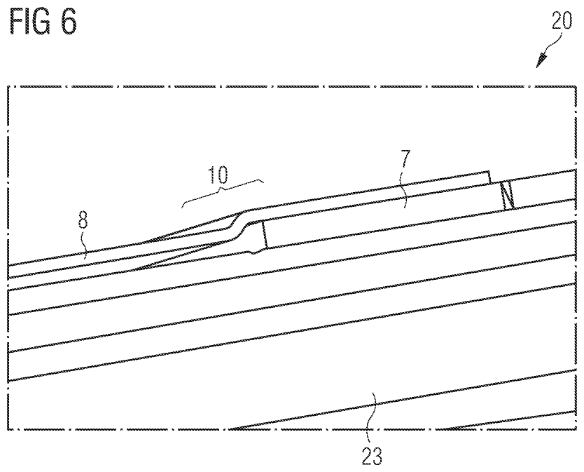

FIG. 6 is an additional perspective cross-section with two roof frame elements according to an embodiment of the invention,

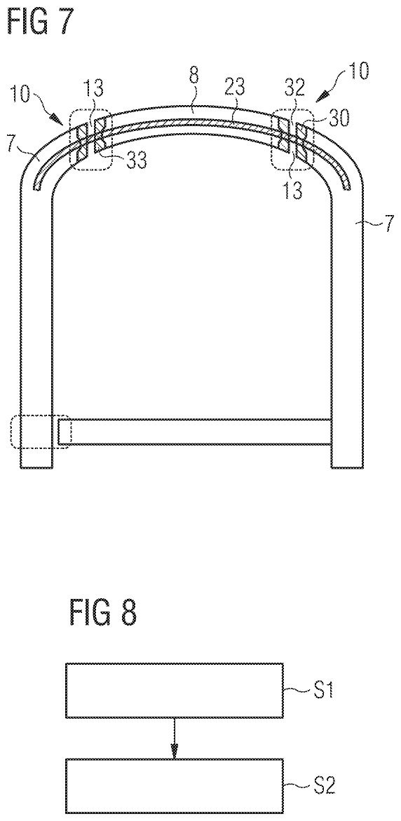

FIG. 7 is a schematic plan view of roof frame elements according to an additional embodiment of the invention, and

FIG. 8 is a schematic flow chart of a production method of the seal between two roof frame elements.

FIG. 1 is a schematic, perspective view of a vehicle roof 1 of a motor vehicle 2. A longitudinal vehicle direction 3 extends from the windshield in the direction of a vehicle rear. The longitudinal direction 3 corresponds to the X direction of the vehicle rear depicted. The vehicle roof 2 has a roof opening 4 which is completely closed by two transparent covers 5 and 6 in FIG. 1. The first cover 5 which is also referred to as the front cover is movable backward in the X direction relative to the vehicle roof 2 so that the roof opening 4 can be released at least partially. The second cover 6 is intended to be understood to be a fixed roof element and is fixedly connected to the vehicle roof 1. The first cover 5 is intended to be viewed as a portion of a sliding roof, for example, an externally guided sliding roof. For example, the cover 5, 6 involves glass covers or panorama sun roofs. Alternatively, the vehicle roof 1 has only one cover. Optionally, the first cover 5 is a non-movable roof element.

A roof frame which comprises a plurality of roof frame elements is formed along an edge of the roof opening 4. The roof frame elements are sheet metal elements which are welded to each other, for example, spot-welded. However, other connection techniques are conceivable.

FIG. 2 is an exemplary perspective illustration of a first roof frame element 7 and a second roof frame element 8 in an arrangement 20. The two roof frame elements 7 and 8 are arranged on each other so that they overlap at least partially at the free ends 9. In other words, the two roof frame elements 7 and 8 form an overlap region 10. The two roof frame elements 7 and 8 are constructed in the overlap region 10 so that either surfaces 18 of upper sides 11 or surfaces 19 of lower sides 12 of the two roof frame elements 7 and 8 are flush. In the embodiment shown, the upper sides 11 are partially flush and the lower sides 12 are partially flush. In other words, butt-joints or butt-joint locations are involved in the overlap region 10.

At least one gap 13 is formed in the overlap region 10. Typically, adhesive beads or adhesive seals, as set out below, can intersect with the overlap region 10 and consequently the gap 13.

In order to avoid leaks between the gap 13 and such adhesive beads or adhesive seals, the gap 13 is filled, for example, in a filling process manually with filler mass, as shown in FIG. 3 schematically as a cross-section. A gap seal 14 is thereby formed. However, it has been recognized that this complex, manual process is connected with high costs, provides a poor level of reproducibility and furthermore sinking locations which have a particularly disadvantageous effect on the sealing can occur.

FIG. 4 schematically shows an arrangement 20 having two roof frame elements 7 and 8, in which the gap seal 14 is produced in accordance with an embodiment of the invention. The production of the gap seal 14 is explained with reference to the flow chart schematically illustrated in FIG. 8.

Instead of the manual process, in a first step S1, as described above, the two roof frame elements 7 and 8 are prepared.

In an additional step S2, a hardening sealing material 15 is introduced into the gap 13 by means of an applicator device 16 with mechanical support. To this end, the applicator device 16 has, for example, a spray head 17, by means of which it applies the sealing material 15 in a pressureless method, for example, a WST method mentioned in the introduction. The sealing material 15 is a low-viscosity material which flows into the gap 13 and hardens at that location. The gap seal 14 is thereby formed. Such a material is in the form, for example, of an epoxy hybrid or has an epoxy hybrid. The material may also be a PVC plastisol.

In this case, the sealing material 15 is introduced into the gap 13 so that the gap seal 14 terminates flush with the two roof frame elements 7 and 8. The gap seal 14 consequently has a smooth sealing surface 21 which together with the surfaces 18 which adjoin the gap seal 14 forms a common surface. Consequently, the gap seal 14 does not have any sinking locations, whereby a particularly good sealing effect is achieved, particularly as described below in conjunction with intersecting adhesive beads or adhesive materials.

In the production method described, the applicator device 16 is moved, for example, along the gap 13 in order to introduce the sealing material 15. In addition to a movement speed, additional process parameters of the method, for example, a volume flow of the sealing material 15 from the applicator device 16, can also be controlled. Consequently, a robot-supported method which ensures a high level of operational reliability is involved.

In order to further influence the gap seal 14 with regard to the shaping thereof, optionally as mentioned in the introduction one or more shaping components can be positioned on the roof frame elements 7 and/or 8 (see FIG. 7) which have one or more shaping faces 33 which form a hollow space or a cavity together with the gap 13. The sealing material 15 is introduced into this cavity and the surrounding faces of the roof frame elements 7, 8 and the shaping faces 33 of the shaping component(s) 30 are formed. Optionally, as mentioned in the introduction, a resilient lip can be provided so that a closed cavity can be formed and consequently the shaping of the gap seal 14 is predetermined at each side or surface.

FIGS. 5 and 6 show two additional embodiments of arrangements 20 as a perspective cross-section with two roof frame elements 7 and 8 in accordance with the previously described embodiment.

FIG. 5 illustrates additional elements which are not, however, explained in greater detail. FIG. 5 illustrates an adhesive seal 22, for example, a joint seal, which is adhesively bonded over both roof frame elements 7 and 8 and the gap 13. The adhesive seal 22 intersects with the gap 13. A gap seal (not illustrated) is introduced into this gap 13 as described above. Fluid-tightness is present between the gap seal and the adhesive seal 22.

FIG. 6 is a perspective view of an adhesive bead 23 which is applied similarly to the adhesive seal 22 to the two roof frame elements 7, 8 and the gap seal (not illustrated).

FIG. 7 illustrates an additional embodiment of the invention as a schematic view of the roof frame elements 7 and 8. The roof frame element 8 produces, for example, a front transverse strut which is connected at opposite ends to two longitudinal struts which produce a respective roof frame element 7. In the overlap regions 10, a respective gap seal 14 is formed in the associated gap 13.

By means of the shaping component 30, the formation and hardening of the gap seal 14 can be carried out in a particularly reliable and controlled manner. The shaping component 30 is, for example, constructed in two pieces and has a separate upper portion and lower portion. The sealing of the gap 13 or a portion thereof can be carried out by means of such a shaping component 30 at an upper side and/or a lower side of the roof frame elements 7, 8. For example, the overlap region 10 has between the two roof frame elements 7 and 8 both at the upper side and at the lower side a respective gap 13, within which a respective gap seal 14 is formed by means of the method described in order to fill undesirable empty spaces and to contribute to a reliable sealing.

The shaping component 30 is, for example, produced from silicone or has silicone at least in the region of the shaping face 33 which moves into abutment with the upper side and/or the lower side of one or both roof frame element(s) 7 and 8 and consequently produces a soft shaping tool which reliably delimits an inward flow of low-viscosity sealing material 15 and which allows a particularly flush and attractive final result in relation to the formation of the gap seal 14.

In order to let in the sealing material 15, the shaping component 30 may have one or more inlet openings 32 which allow(s) controlled introduction of the sealing material 15 into the gap 13 or the cavity which is formed with the gap 13 and the shaping component 30. Alternatively or additionally, the shaping component 30 may have an open front or rear side, through which the sealing material 15 can be introduced by means of the applicator device 16.

At this point, it may be noted that the described method is also suitable for sealing other roof frame elements or roof components for a vehicle roof.

### LIST OF REFERENCE NUMERALS

1 Vehicle roof

2 Motor vehicle

3 Longitudinal vehicle direction

4 Roof opening

5 First cover

6 Second cover

7 First roof frame element

8 Second roof frame element

9 Free end

10 Overlap region

11 Upper side

12 Lower side

13 Gap

14 Gap seal

15 Sealing material

16 Applicator device

17 Spray head

18 Surface of the upper side

19 Surface of the lower side

20 Arrangement

21 Sealing surface

22 Adhesive seal

23 Adhesive bead

30 Shaping component

32 Inlet opening of the shaping component

33 Shaping face of the shaping component

1. A method for producing a seal between two roof frame elements for a vehicle roof having the steps of:
providing the two roof frame elements in such a manner that an overlap region is formed, wherein at least one gap is formed in the overlap region;
mechanically supported introducing of a hardening sealing material into the gap by an applicator device in such a manner that the sealing material flows into the gap and subsequently hardens in order to form a gap seal.

2. The method according to claim 1, wherein at least one of a movement of the applicator device and a volume flow of the sealing material from the applicator device for introduction into the gap are mechanically controllable.

3. The method according to claim 1, wherein the sealing material is introduced into the gap in such a manner that the sealing material hardens so as to form a smooth sealing surface.

4. The method according to claim 1, wherein a shaping component is placed against either the first or the second roof frame element along at least a portion of the gap, wherein the shaping component has a shaping face and delimits, together with the gap, a cavity, into which the sealing material is introduced.

5. The method according to claim 4, wherein the shaping component is constructed in two pieces and has an upper portion and a lower portion so that the gap seal is formed in at least one of an upper side and a lower side of the roof frame elements.

6. The method according to claim 4, wherein the shaping component is produced from silicone.

7. The method according to claim 4, wherein the shaping component has an inlet opening, through which the sealing material is introduced into the cavity and subsequently hardens in order to form the gap seal.

8. The method according to claim 4, wherein the shaping component has a resilient lip which can be displaced by means of the applicator device in order to provide access to the cavity.

9. The method according to claim 4, wherein an additional shaping component is positioned along at least the portion of the gap so that both shaping components delimit, with the gap, a closed cavity into which the sealing material is introduced.

10. The method according to claim 1, wherein, after the introduction of the sealing material, comprises an additional step of applying an adhesive material to the two roof frame elements in such a manner that the adhesive material or the adhesive seal intersects in a fluid-tight manner with the sealing material which has hardened in the gap.

11. The method according to claim 1, wherein the method for producing the seal is approximately one of a WST method and a WST+ method.

12. An arrangement with two roof frame elements for a vehicle roof of a motor vehicle, wherein
the two roof frame elements are arranged in such a manner that an overlap region is formed, wherein at least one gap is formed in the overlap region; and
a hardening sealing material is introduced into the gap according to a method according to one claim 1 so that a gap seal is formed.

13. The arrangement according to claim 12, wherein an adhesive material is applied to the two roof frame elements in such a manner that the adhesive material intersects in a fluid-tight manner with the sealing material which has hardened in the gap.

14. The method according to claim 4, wherein the shaping component has silicone at least in the region of the shaping face.

15. The method according to claim 10, wherein the step of applying an adhesive material results in an adhesive bead.

16. The method according to claim 10, wherein the step of applying an adhesive material results in an adhesive seal.

17. The arrangement according to claim 13, wherein the adhesive material is an adhesive bead.

18. The arrangement according to claim 13, wherein the adhesive material is an adhesive seal.
